(19) United States
(12) Patent Application Publication
(10) Pub. No.: US 2014/0258157 A1
(43) Pub. Date: Sep. 11, 2014

(54) Feedback for Financial Contributions

(71) Applicants: Keenan Pridmore, Chicago, IL (US); Philip John MacGregor, IV, Chicago, IL (US); Robert Newlan, London (GB); Tom Elliott, London (GB)

(72) Inventors: Keenan Pridmore, Chicago, IL (US); Philip John MacGregor, IV, Chicago, IL (US); Robert Newlan, London (GB); Tom Elliott, London (GB)

(21) Appl. No.: 13/787,617

(22) Filed: Mar. 6, 2013

(51) Int. Cl. G06Q 40/00; G06Q 50/00

(52) U.S. Cl. CPC G06Q 40/00; G06Q 50/01
USPC 705/319

(57) ABSTRACT

Exemplary methods, apparatuses, and systems display selectable partners to facilitate a financial contribution from a user, receive user selection of one of the partners and an amount of the financial contribution, receive partner feedback to demonstrate an impact of the financial contribution, and display the feedback to the user. The feedback includes a photograph taken of a beneficiary of the financial contribution upon receiving benefit of the financial contribution. The partner submits the feedback to an organizer for review and the organizer approves and provides the feedback to the user.

### FIELD

The various embodiments described herein relate to providing financial contributors with feedback to demonstrate the impact of their financial contributions. In particular, the embodiments relate to the utilization of a social networking platform to provide the feedback and encourage additional contributions.

### BACKGROUND

A social networking system allows users to designate other users or entities as connections (or otherwise connect to, or form relationships with, other users or entities), contribute and interact with their connections, use applications, join groups, list and confirm attendance at events, invite connections, and perform other tasks that facilitate social interaction. External applications also use the services of a social networking system to allow authenticated users to incorporate some of the above social interactions with use of the external applications.

### SUMMARY OF THE DESCRIPTION

Exemplary methods, apparatuses, and systems display selectable partners to facilitate a financial contribution from a user, receive user selection of one of the partners and an amount of the financial contribution, receive partner feedback to demonstrate an impact of the financial contribution, and display the feedback to the user. The feedback includes a photograph taken of a beneficiary of the financial contribution upon receiving benefit of the financial contribution. The partner submits the feedback to an organizer for review and the organizer approves and provides the feedback to the user.

In one embodiment, the feedback further includes text describing the impact of the financial contribution. In one embodiment, the photograph includes a time stamp to demonstrate that the feedback is contemporaneous with the beneficiary receiving benefit of the financial contribution.

Other features and advantages will be apparent from the accompanying drawings and from the detailed description.

### BRIEF DESCRIPTION OF THE DRAWINGS

The present invention is illustrated by way of example and not limitation in the figures of the accompanying drawings, in which like references indicate similar elements, and in which:

FIG. 1 illustrates, in block diagram form, an exchange between a user, social networking system, and a partner to facilitate the distribution of a financial contribution and provide feedback to demonstrate the impact of the financial contribution;

FIG. 2 is a flow chart illustrating an exemplary method of receiving feedback to demonstrate an impact of a financial contribution;

FIG. 3 illustrates an exemplary graphical user interface (GUI) window displaying a social networking platform log in for an organization's application;

FIG. 4 illustrates an exemplary GUI window displaying selectable partners to facilitate the financial contribution;

FIG. 5 illustrates the exemplary GUI window displaying the publication to a social networking platform;

FIG. 6 illustrates the exemplary GUI window displaying selectable options for financial contributions;

FIG. 7 illustrates the exemplary GUI window displaying feedback demonstrating the impact of one or more financial contributions;

FIG. 8 illustrates an exemplary exchange between a user, organizer, and partner facilitating the distribution of and feedback regarding a contribution;

FIG. 9 illustrates, in block diagram form, an exemplary social network; and

FIG. 10 illustrates, in block diagram form, an exemplary processing system to provide or receive feedback to demonstrate an impact of a financial contribution.

### DETAILED DESCRIPTION

Embodiments described herein utilize a social networking platform to provide feedback from a partner to a user that demonstrates the impact of a financial contribution from the user and encourage additional contributions from the user and the user's connections. Feedback such as a photograph taken of a beneficiary of the financial contribution, and/or descriptive text of the benefit provided by the financial contribution, provides transparency for the contribution process, which keeps the user engaged. In some embodiments, an organizer reviews, approves, and provides the feedback to the user. In one embodiment, the organizer's review and approval includes determining that the feedback is contemporaneous with the beneficiary receiving benefit of the financial contribution and provides a buffer between the user and partner.

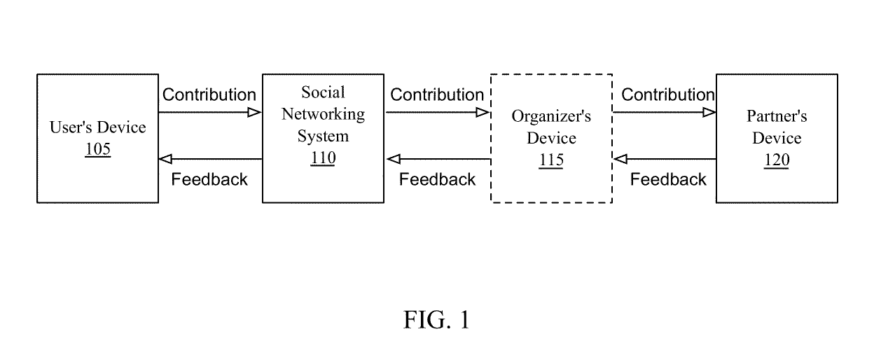

FIG. 1 illustrates, in block diagram form, a cycle of an exchange between a user, social networking system, and a partner to facilitate the distribution of a financial contribution from a user to a partner and provide of feedback from the partner to the user to demonstrate the impact of the financial contribution. As will be discussed in greater detail below, a user makes a financial contribution via a processing device 105 coupled to a social networking system 110. The social networking system 110 facilitates the distribution of the financial contribution to a partner selected by the user, rather than transferring the financial contribution generally to an organization. In one embodiment, the financial contribution is optionally transmitted to an organization rather than directly to the partner. The organization may facilitate micro-loans, crowd sourcing to fund projects, charitable giving, etc. The financial contribution is used to purchase goods, provide funding, or otherwise provide a benefit to be distributed by the partner. In one embodiment, notification of the user's contribution is transmitted from the organizer's device 115 to the partner's device 120 to notify the partner to distribute the benefit of the user's contribution. Alternatively, the partner is notified verbally or by another means. The partner documents the impact of the financial contribution, e.g., by capturing a photograph or video with the partner's device 120, and transmits the documented impact as feedback to the user's device 105 via the social networking system 110 and, optionally, via the organizer's device 115. In one embodiment, the feedback includes a written description of the impact. For example, the partner may compose written feedback using an applicable template and include the written feedback along with a photograph or video. When transmitted via the organizer's device, the feedback is optionally reviewed and approved on the organizer's device 115 and the reviewed and approved feedback is transmitted to the user's device 105 via the social networking system 110. For example, transmission of the feedback includes sending it in a message or publishing it as a post within the social networking system 110. This cycle of contribution and feedback provides transparency for the contribution process, keeps the user engaged, and encourages the user and others that are able to view the feedback to make additional financial contributions.

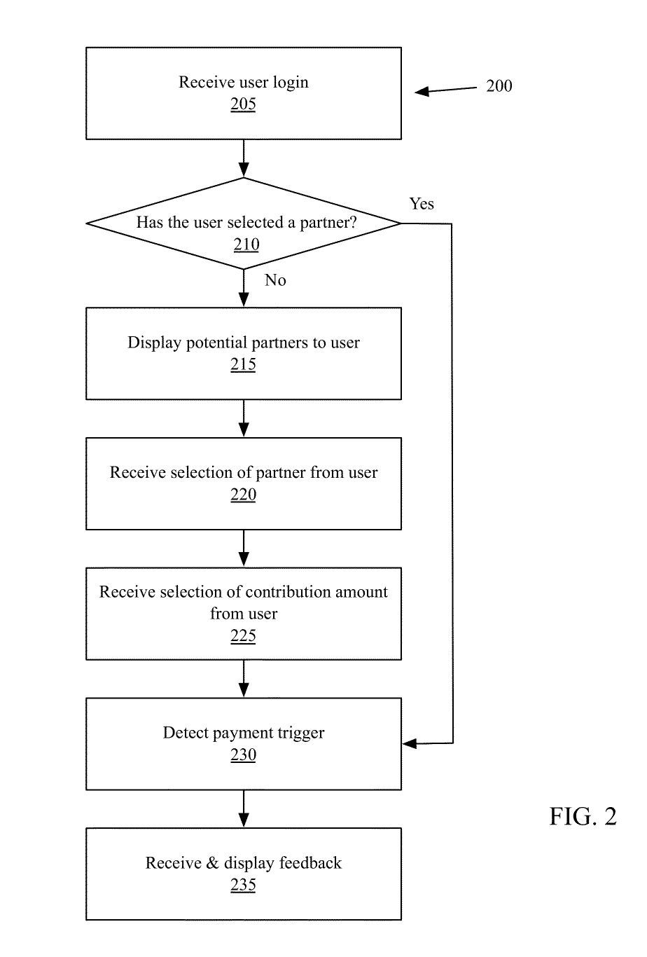

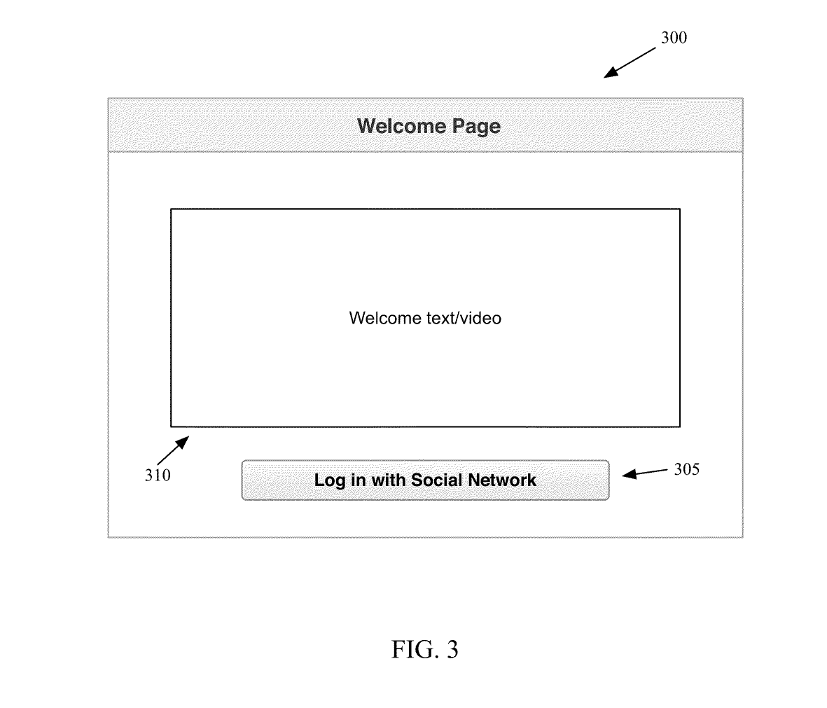

FIG. 2 is a flow chart illustrating an exemplary method 200 of providing feedback through a social network to demonstrate an impact of a financial contribution. The method 200 is executed by one or more processing devices and will be described with reference to graphical user interface (GUI) window displays illustrated in FIGS. 3-7. The method 200, however, is not limited to an implementation that includes the illustrated interfaces described below. For the ease of explanation, the method 200 will be primarily described from the “vantage point” of the social networking system 110.

At block 205, the user's device is provided with a log in screen to the organization's application. In one embodiment, a landing or welcome page for an organization's application or website that facilitates financial contributions includes log in functionality to provide security for users and is, e.g., displayed to the user via the social networking system 110. In one embodiment, the organization's application is an external application that operates in a cooperative manner with the social networking system 110 (e.g., enabling access to user connections, having permission to publish posts, etc.). In an alternative embodiment, the organization's application is an internal application that operates within or as a part of the social networking system 110. In one embodiment, the user registers for and utilizes a username and password with the organization and enters the username and password into corresponding text input boxes. Alternatively, the user logs in using another account, e.g., using a social networking account.

FIG. 3 illustrates an exemplary GUI window 300 on the user's processing device displaying a social networking platform log in 305 for the organization's application. This welcome page for the organization may include informational text, images, and/or video 310 to encourage users to make financial contributions to the organization. In one embodiment, user selection of the log in button 305 presents the user with a pop up or different GUI window to enter a username and password for the user's social networking account. In an alternate embodiment, if the user has already logged in to the social networking account, selection of the log in button 305 causes an automatic log in, e.g., using a cookie stored by the user's processing device.

In one embodiment, if the user has not previously logged in to organization's application using the social networking account, the social networking platform requests that the user approve and/or select permissions for the organization's application with respect to the user's social networking account. For example, the social networking platform requests that the user approve or select account information that will be made available to the organization's application or permissions regarding the organization application's ability to publish content to the user's social networking account.

Referring back to FIG. 1, at block 210, the organization's application or the social networking system 110 determines if the user has previously selected a partner to facilitate financial contributions for an intended benefit. If a partner has not been selected or if the user would like to select a new partner, at blocks 215 and 220, the social networking system 110 displays to the user (via the user's device 105) one or more selectable partners and receives selection of a partner.

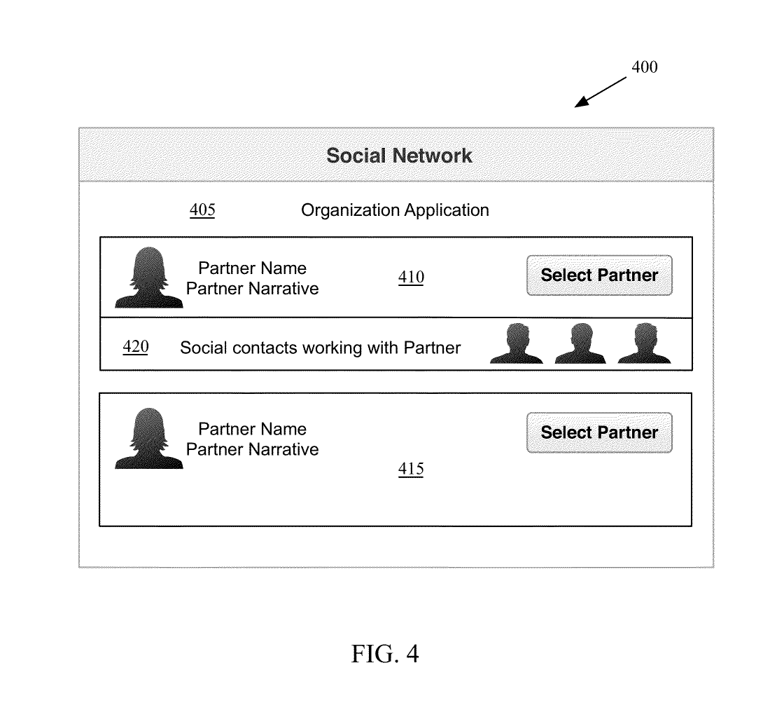

FIG. 4 illustrates an exemplary GUI window 400 displaying the organization's application 405 with selectable partners 410 and 415 to facilitate a user's financial contribution to a partner through the organization. The display of a selectable partner includes one or more of: an image associated with the partner, the partner's name, partner's location, or a narrative/descriptive text for the partner. In one embodiment, various data and metadata about the partner is stored (e.g., by the social networking system 110 or the organization on a storage device that is external to the social networking system 110). The data and/or metadata about the partner may be filtered to present a list of partners. In one embodiment, e.g., when the user has logged in using the social network and granted the organization application 405 access to the user's social network connections, the display of a selectable partner further includes one or more contacts 420 associated with the user's social networking account that have previously selected the partner. The display of these contacts 420 enables the user to quickly find a partner that is liked by friends, join a team effort in making financial contributions, select an unrepresented partner amongst the user's connections, etc. In one embodiment, the social networking system 110 provides the user's device 105 with content to display additional partners in response to scrolling input, refreshing a webpage, or selection of a link/button. In one embodiment, the user may be first presented with a plurality of selectable organizations, themes, charitable causes, etc. prior to being presented with a selectable partner. Alternatively, the user may choose an organization without selecting a partner and receives feedback as described herein from the organization.

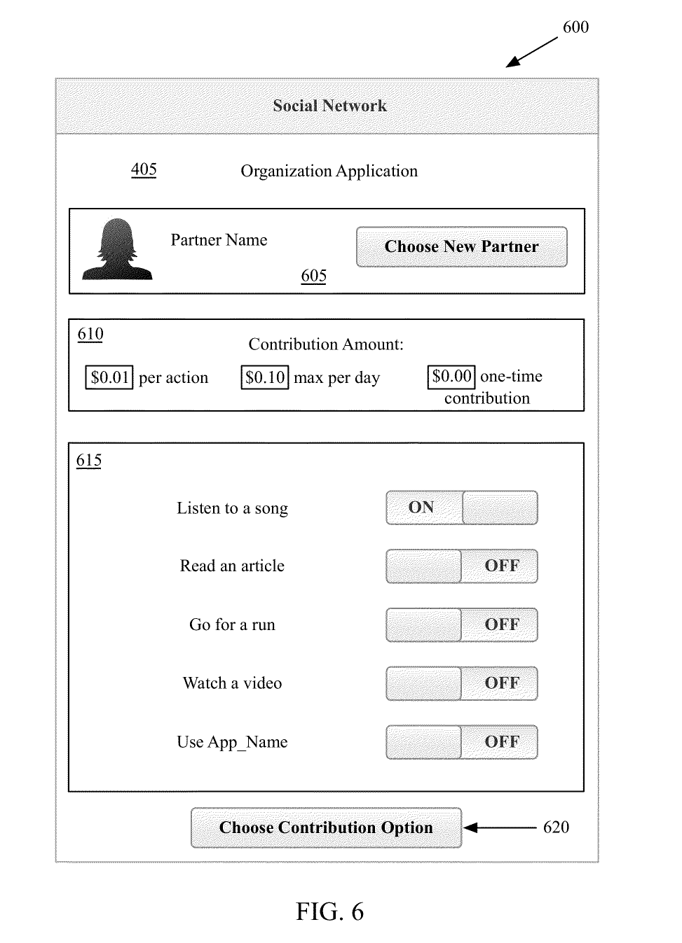

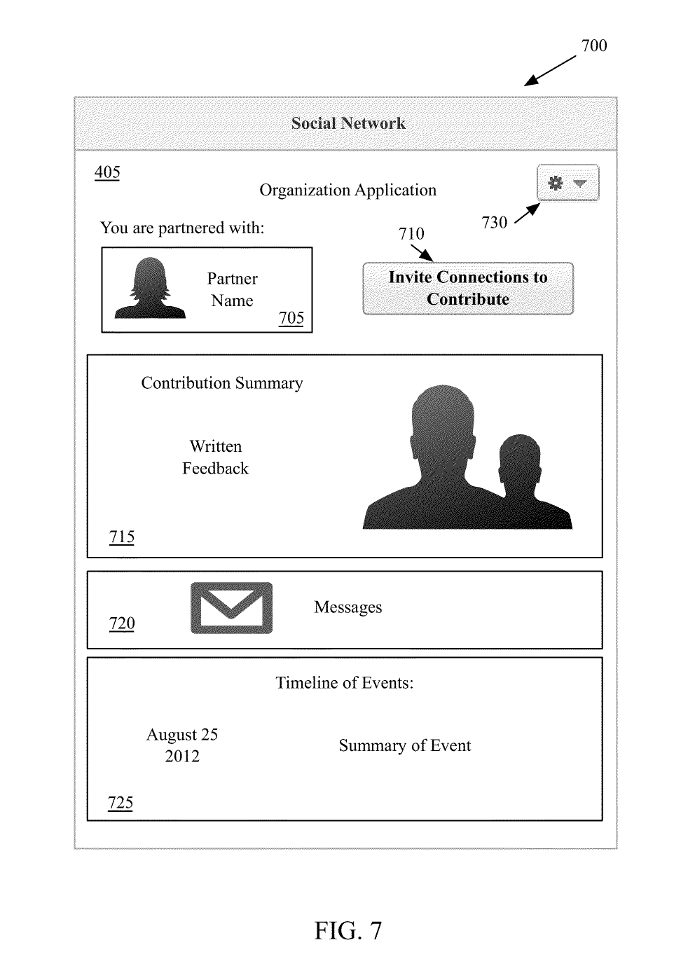

As described above, the social networking system 110 facilitates the distribution of the financial contribution to the partner selected by the user, rather than transferring the financial contribution generally to an organization. The display of one or more of an image of the partner, her name, her location, and a narrative description about her personalizes the recipient/distributor of the financial contribution. In one embodiment, the financial contribution is applied only to the selected partner as a recipient or to the selected partner's salary, materials, training, and/or distributions made by the selected partner and is not otherwise applied to generally fund the efforts of an organization to which the partner belongs or is associated. The user is not left simply trusting that an organization will apply the funds in a sensible manner. In combination with the feedback described herein, this funding model provides transparency for a user making a financial contribution via a personalized, selected partner. Once the user has selected a partner, the selected partner may be displayed on various pages within the organization's application, e.g., as described below with reference to FIGS. 6 and 7. In one embodiment, the organization's application automatically publishes content to a social networking platform on behalf of the user in response to the selection of a partner.

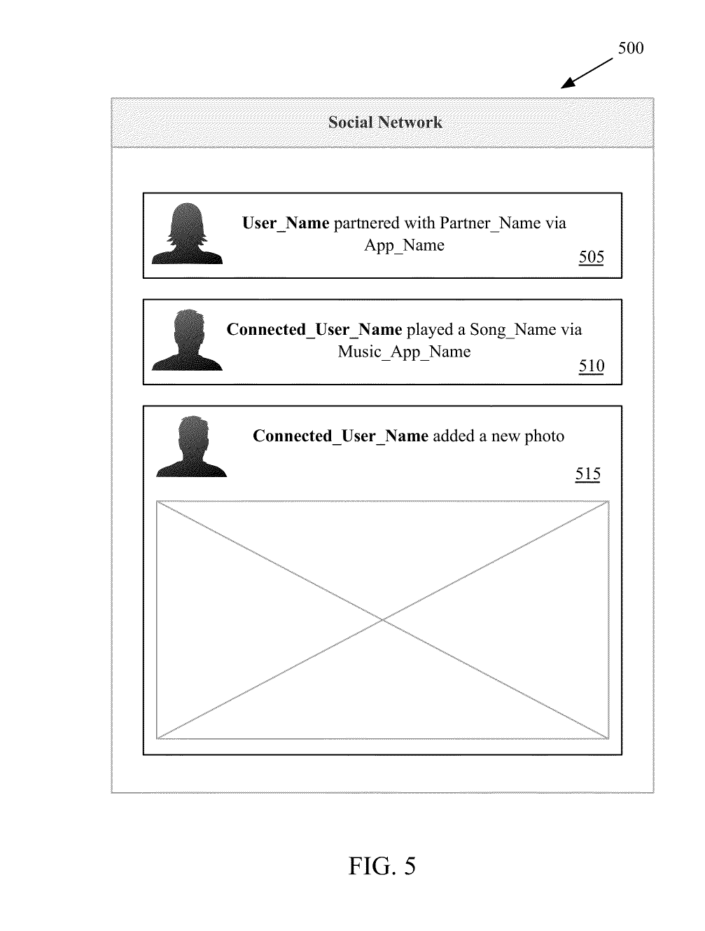

FIG. 5 illustrates the exemplary GUI window 500 displaying the publication 505 of the user selecting a partner to a social networking platform. The partner selection publication 505 may appear on a profile page/feed for the user and/or in a feed of publications/posts viewed by one or more users of the social networking platform. The exemplary GUI window 500 shows a feed that also includes publications 510 and 515 by another user. The partner selection publication 505 brings attention to the user's partner selection and/or financial contribution activity and may result in other users selecting a partner and making financial contributions.

Referring back to FIG. 2, at block 225, the processing device receives one or more user selections for a one-time or recurring financial contribution to the selected partner. In one embodiment, an amount of a financial contribution is entered into a text box. Alternatively, the financial contribution is selected from a menu of preset amounts. For recurring payments, payment occurs automatically in response to the expiration of a time period (e.g., daily) or in response to the processing device detecting a particular user action (described below).

FIG. 6 illustrates the exemplary GUI window 600 of the organization's application 405 within the social networking system and displaying selectable options for financial contributions. The exemplary GUI window 600 includes a display 605 of the currently selected partner and button to enable the user to select a new partner (e.g., by returning the user to the exemplary GUI window 400 described above). A contribution amount section 610 includes a text box or menu to select a recurring amount to contribute per action and a text box or menu to select a maximum amount to contribute per day. Alternatively, the contribution amount display 610 includes only a text box or menu to select a contribution amount per time period (e.g., per day, per week, per month, or per year).

The GUI window 600 may also include an action selection section 615. Exemplary user actions include listening to a song, reading an article, going for a run, watching a video, or using a particular application. Detection of an action, for example, includes detecting an application's posting of the user's activity to the social network. One or more applications on the processing device may be selected by the user or preset by the organization's application as optional triggers. Each action may be selected, alone or in combination, as a trigger for an automatic payment. When the selectable options reflect the financial contributions the user would like to make, the user confirms the options by selecting a confirmation button 620.

Referring back to FIG. 2, at block 230, after receiving selection of a partner and contribution amount, the processing device waits to detect a trigger to make a payment. As described above, the trigger may be the expiration of a time period (e.g., daily), a particular user action, an action by the partner, etc. For example, if the processing device detects that the user is running based upon input from an accelerometer, positioning system, and/or running tracking application, and an option is set to make a payment each time the user goes for a run, the running triggers a payment.

At block 235, the processing device receives and displays feedback from the selected partner to demonstrate an impact of the financial contribution. The feedback typically includes a photograph or video taken of a beneficiary of the financial contribution upon receiving benefit of the financial contribution or otherwise visually demonstrating the impact of the financial contribution. Additionally, or alternatively, the feedback includes text describing the impact of the financial contribution. In one embodiment, the text is generated from a template, which may include “canned” content.

FIG. 7 illustrates the exemplary GUI window 700 displaying feedback demonstrating the impact of one or more financial contributions. The feedback may be displayed within the organization's application 405, running independently of the social networking platform or within the social networking platform, or the feedback is displayed within the social networking platform itself (e.g., similar to the display described with reference to FIG. 5).

The exemplary GUI window 700 displays a partner section 705 including a picture of and/or text describing the user's selected partner. In one embodiment, user interaction with the partner section 705 causes the display to alternate between a picture and a short biography or other description of the partner. In one embodiment, user interaction with the partner section 705 provides the user with the opportunity to select a new partner (e.g., as described with reference to FIG. 6).

The exemplary GUI window 700 includes an invite button 710. User selection of the invite button 710 results in a pop up window, separate GUI window, message window, etc. to enable the user to invite social networking connections or contacts to make a financial contribution or partner with the selected partner. In one embodiment, the invite is sent as a private message directly to one or more connections. Alternatively, the invite is published to the social networking platform.

The exemplary GUI window 700 further includes a contribution summary section 715. The contribution summary section 715 includes a summary of the impact of the user's cumulative financial contributions. Alternatively, if one or more of the user's contacts or social networking connections have also partnered with the user's selected partner, the contribution summary section 715 includes a summary of the impact of the user and connection's cumulative financial contributions. In one embodiment, the contribution summary section 715 further includes one or more photographs or videos taken of a beneficiary of the financial contribution upon receiving benefit of the financial contribution or otherwise visually demonstrating the impact of the financial contribution. Additionally, or alternatively, the feedback includes text describing the impact of the financial contribution.

The exemplary GUI window 700 includes one or more messages 720. In an embodiment displaying multiple messages 720, the messages may be displayed in chronological order. A message 720 includes feedback similar to the description above, e.g., one or more photographs or videos taken of a beneficiary of the financial contribution upon receiving benefit of the financial contribution or otherwise visually demonstrating the impact of the financial contribution. Additionally, or alternatively, the feedback includes text describing the impact of the financial contribution. In one embodiment, each message 720 corresponds to the impact of one or more financial contributions within a period of time, e.g., for a given day, week, month, or year. Alternatively, each message 720 corresponds to the impact of a defined amount of financial contributions, e.g., a defined threshold, an amount that corresponds to the purchase of a particular item, etc. In one embodiment, the feedback is displayed in a feed that can only be viewed by the user. Alternatively, other users can view the feed. In one embodiment, the feedback within a message 720 is automatically displayed upon the user loading the feed. Alternatively, the message 720 includes an indication of a new message is available. User interaction with the message expands the message 720 to display the feedback or, alternatively, opens the feedback in a pop up or separate GUI window.

In one embodiment, the exemplary GUI window 700 includes a timeline 725 of other events or posts. For example, if the user selected a partner on Aug. 25, 2012, the timeline 725 includes a summary of the selection, which may include one or more of a picture, video, and descriptive text. Exemplary events or posts include users connected to the user selecting the user's partner, impacts of financial contributions, informational posts regarding the purpose of the financial contributions, etc.

In one embodiment, the partner submits the feedback to an organizer for review and the organizer approves and provides the feedback to the user. In one embodiment, the organizer's review and approval includes determining that the feedback is contemporaneous with the beneficiary receiving benefit of the financial contribution. For example, when the partner takes a photograph of the impact of the financial contribution, the photograph includes a time stamp. The organizer reviews the time stamp to determine whether or not the photograph is contemporaneous with the financial contribution and/or the beneficiary receiving benefit of the financial contribution. In one embodiment, the determination whether or not the feedback is contemporaneous with the contribution or impact is performed by an automated organizer. For example, a processing device receives the photograph, locates a time stamp in the photograph's metadata, and compares the date of the time stamp with the present date, a date of a financial contribution, or a date of the corresponding feedback.

The organizer provides a buffer between the user and partner. For example, communications between the user and the partner are passed through the organizer. The organizer reviews the content of the communications to determine if the content is appropriate and of a particular level of quality. Exemplary appropriate content includes feedback and information regarding the financial contributions and impact of financial contributions. Exemplary inappropriate content includes solicitations for contributions unrelated to the organization or not approved by the organization. In one embodiment, the determination whether or not the content is appropriate is performed by an automated organizer. For example, a processing device receives the content of the communication and compares the text of the communication (e.g., using a diff program) with preapproved messages to determine if the content matches preapproved content to a threshold percentage or amount or includes/does not include key words or phrases.

The exemplary GUI window 700 further includes a settings button 730. User selection of the settings button 730 opens a menu, pop-up GUI window, or otherwise displays settings options for the user. For example, the user may select or change which types of feedback or posts from a partner are published on the social network, financial contribution amounts or triggers, a selected partner, or end recurring financial contributions.

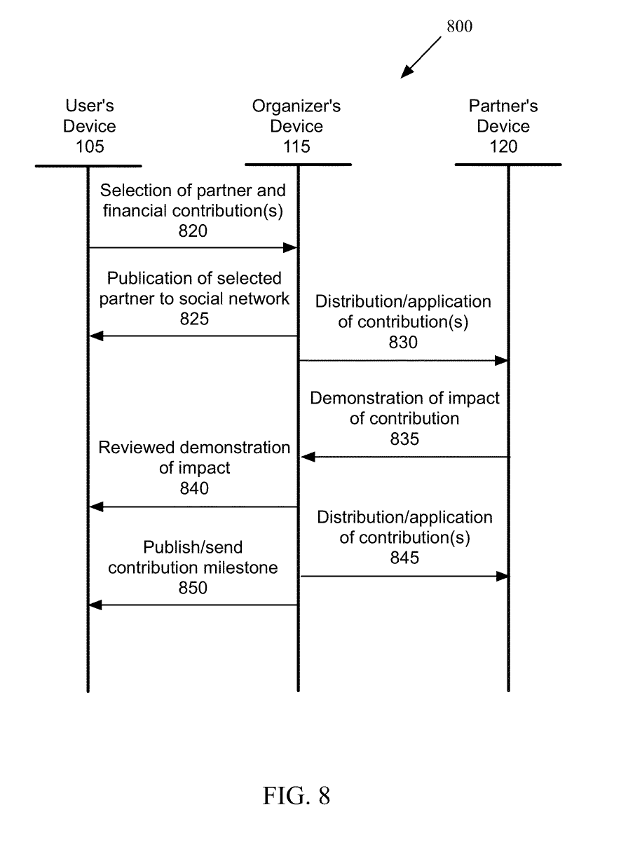

FIG. 8 illustrates an exemplary exchange 800 between a user's device 105, organizer's device 115, and a partner's device 120, the exchange 800 facilitating the distribution of and feedback regarding one or more financial contributions. As described above with reference to FIG. 1, the exchange 800 may occur through the social networking system 110. During the exchange 800, a user's device 105 transmits the selection of a partner to an organizer's device 115. The selection of a partner is optionally published 825 to the user's social networking account. In one embodiment, notification of the user's financial contribution 830 is transmitted from the organizer's device 115 to the partner's device 120 to notify the partner to distribute the benefit of the user's financial contribution. Alternatively, the partner is notified verbally or by another means. The partner captures a photograph or video of the impact of the financial contribution with the partner's device 120 and transmits it as feedback 835 to the organizer's device 115 as evidence of the benefit provided by the user's financial contribution. Additionally, or alternatively, the feedback 835 includes a written description of the impact. For example, the partner may compose written feedback using an applicable template and include the written feedback along with a photograph or video. The feedback is reviewed and approved on the organizer's device 115 as described above. The reviewed and approved feedback 840 is transmitted to the user's device 105. Exemplary transmission of the feedback 840 includes sending it in a message, publishing it as a post within the organizer's application when accessed by the user, or publishing it as a post within the user's social networking account. In an embodiment in which the user makes recurring or multiple financial contributions, notification of the user's additional financial contribution(s) 845 is transmitted from the organizer's device 115 to the partner's device 120 to notify the partner to distribute the benefit of the user's financial contribution. Alternatively, the partner is notified verbally or by another means. Feedback is provided to the user as described above. Additionally, when the user's financial contributions reach a defined level or milestone, the organizer's device 115 transmits/publishes a notification of the milestone 850, e.g., sending it in a message, publishing it as a post within the organizer's application when accessed by the user, publishing it as a post within the user's social networking account, or otherwise causing it to be displayed on the user's device 105.

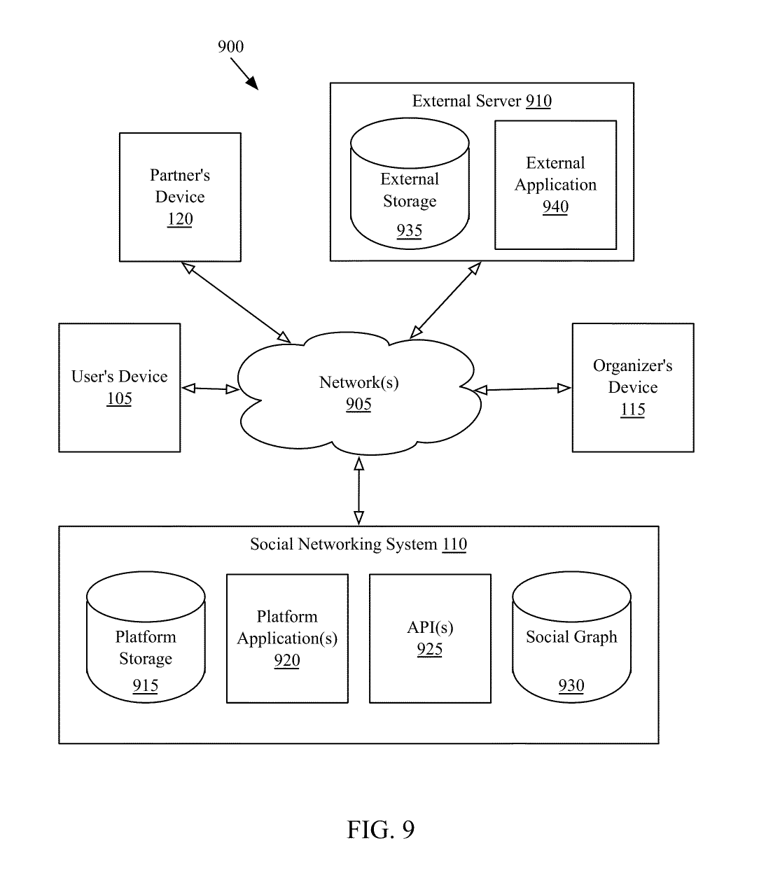

FIG. 9 illustrates, in block diagram form, an exemplary social network 900. The exemplary social network 900 includes a social networking system 110, an external server 910, user's device 105, organizer's device 115, and partner's device 120 coupled to one or more networks 905.

A user interacts with the social networking system 110 using a user's device 105, such as a personal computer or a mobile phone. For example, the user's device 105 communicates with the social networking system 110 via an application such as a web browser or native application. Typical interactions between the user's device 105 and the social networking system 110 include operations such as viewing profiles of other users of the social networking system 110, contributing and interacting with media items, joining groups, listing and confirming attendance at events, checking in at locations, liking certain pages/posts, creating pages, and performing other tasks that facilitate social interaction.

The social networking system 110 includes platform storage 915, one or more platform applications 920, one or more application programming interfaces (API's) 925, and a social graph 930. Platform storage 915 stores user preferences/settings, profile data, etc. Exemplary platform applications 920 include the platform for social interactions (e.g., publishing posts, pictures, etc.) as well as social games, messaging services, and any other application that uses the social platform provided by the social networking system 110. In one embodiment, the organization application 405 is a platform application 920.

One or more API's 925 enable external applications 940 to work with the social networking system 110. For example, an external application 940 utilizes an API 925 to authenticate a user based upon the user's social networking log in username and password. Additionally, an external application 940 utilizes one or more API's 925 to run the application within the platform application 920, to publish a post to the platform application, to access the user's social network connections, etc.

The social graph 930 stores the connections that each user has with other users/entities of the social networking system 110. In one embodiment, the social graph 930 stores second-order connections. The connections may thus be direct or indirect. For example, if user A is a first-order connection of user B but not of user C, and B is a first-order connection of C, then C is a second-order, or indirect, connection of A on the social graph 930. In one embodiment, the social graph 930 provides the organization application 405 with social contacts/connections that are working with a partner or to provide a list of connections to receive invitations to select a partner or make a financial contribution.

The external server 910 includes external storage 935 and an external application 940. The external storage 935 stores authentication data, user preferences, financial contribution data, feedback, etc. The external applications 940 may interact with the social networking system 110 via an API 925. The external applications 940 can perform various operations supported by the API 925, such as enabling users to send each other messages through the social networking system 110 or solicit users to select a partner or make a financial contribution through the social networking system 110. In one embodiment, the organization application 405 is an external application 940.

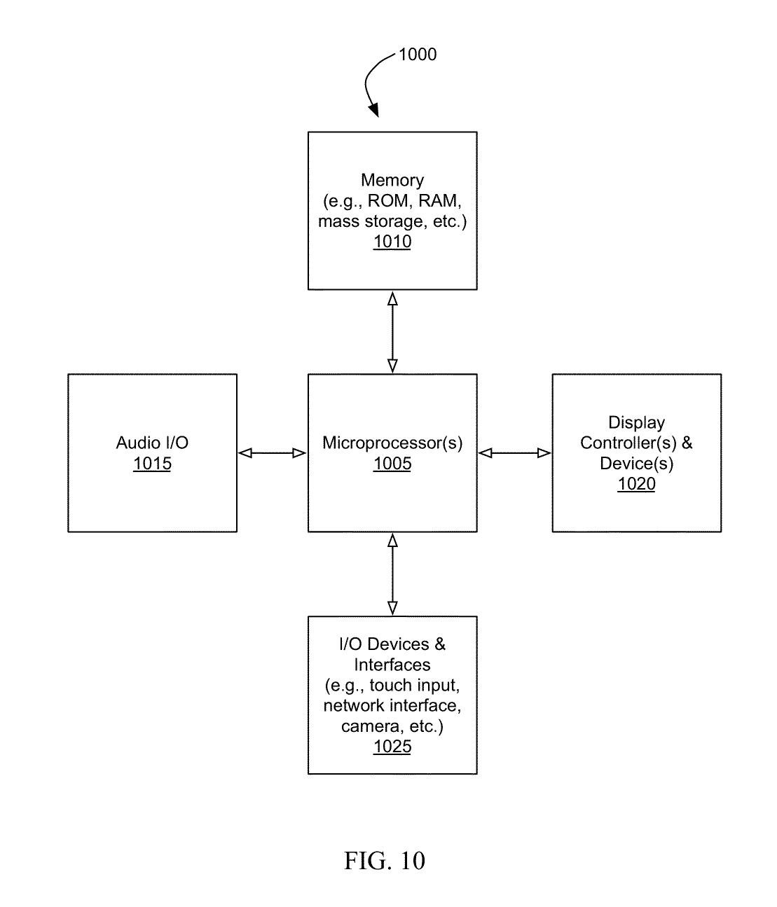

FIG. 10 illustrates, in block diagram form, an exemplary processing system 1000 to provide or receive feedback to demonstrate an impact of a financial contribution. Data processing system 1000 includes one or more microprocessors 1005 and connected system components (e.g., multiple connected chips). Alternatively, the data processing system 1000 is a system on a chip.

The data processing system 1000 includes memory 1010, which is coupled to the microprocessor(s) 1005. The memory 1010 may be used for storing data, metadata, and programs for execution by the microprocessor(s) 1005. The memory 1010 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1010 may be internal or distributed memory.

The data processing system 1000 also includes an audio input/output subsystem 1015 which may include a microphone and/or a speaker for, for example, playing back music or other audio, receiving voice instructions to be executed by the microprocessor(s) 1005, playing audio notifications, etc.

A display controller and display device 1020 provides a visual user interface for the user, e.g., GUI windows illustrated in FIGS. 3-7.

The data processing system 1000 also includes one or more input or output (“I/O”) devices and interfaces 1025, which are provided to allow a user to provide input to, receive output from, and otherwise transfer data to and from the system. These I/O devices 1025 may include a mouse, keypad or a keyboard, a touch panel or a multi-touch input panel, camera, optical scanner, network interface, modem, other known I/O devices or a combination of such I/O devices. The touch input panel may be a single touch input panel which is activated with a stylus or a finger or a multi-touch input panel which is activated by one finger or a stylus or multiple fingers, and the panel is capable of distinguishing between one or two or three or more touches and is capable of providing inputs derived from those touches to the processing system 1000.

The I/O devices and interfaces 1025 may also include a connector for a dock or a connector for a USB interface, FireWire, Thunderbolt, Ethernet, etc. to connect the system 1000 with another device, external component, or a network. Exemplary I/O devices and interfaces 1025 also include wireless transceivers, such as an IEEE 802.11 transceiver, an infrared transceiver, a Bluetooth transceiver, a wireless cellular telephony transceiver (e.g., 2G, 3G, 4G), or another wireless protocol to connect the data processing system 1000 with another device, external component, or a network and receive stored instructions, data, tokens, etc.

It will be appreciated that one or more buses, may be used to interconnect the various components shown in FIG. 10.

The data processing system 1000 is an exemplary representation of the user's device 105, the organizer's device 115, or the partner's device 120. The data processing system 1000 may be a personal computer, tablet-style device, a personal digital assistant (PDA), a cellular telephone with PDA-like functionality, a Wi-Fi based telephone, a handheld computer which includes a cellular telephone, a media player, an entertainment system, or devices which combine aspects or functions of these devices, such as a media player combined with a PDA and a cellular telephone in one device. In other embodiments, the data processing system 1000 may be a network computer, server, or an embedded processing device within another device or consumer electronic product. As used herein, the terms computer, system, device, processing device, and “apparatus comprising a processing device” may be used interchangeably with the data processing system 1000 and include the above-listed exemplary embodiments.

It will be appreciated that additional components, not shown, may also be part of the system 1000, and, in certain embodiments, fewer components than that shown in FIG. 10 may also be used in a data processing system 1000. It will be apparent from this description that aspects of the inventions may be embodied, at least in part, in software. That is, the computer-implemented methods may be carried out in a computer system or other data processing system in response to its processor or processing system executing sequences of instructions contained in a memory, such as memory 1010 or other non-transitory machine-readable storage medium. The software may further be transmitted or received over a network (not shown) via a network interface device 1025. In various embodiments, hardwired circuitry may be used in combination with the software instructions to implement the present embodiments. Thus, the techniques are not limited to any specific combination of hardware circuitry and software, or to any particular source for the instructions executed by the data processing system 1000.

An article of manufacture may be used to store program code providing at least some of the functionality of the embodiments described above. Additionally, an article of manufacture may be used to store program code created using at least some of the functionality of the embodiments described above. An article of manufacture that stores program code may be embodied as, but is not limited to, one or more memories (e.g., one or more flash memories, random access memories—static, dynamic, or other), optical disks, CD-ROMs, DVD-ROMs, EPROMs, EEPROMs, magnetic or optical cards or other type of non-transitory machine-readable media suitable for storing electronic instructions. Additionally, embodiments of the invention may be implemented in, but not limited to, hardware or firmware utilizing an FPGA, ASIC, a processor, a computer, or a computer system including a network. Modules and components of hardware or software implementations can be divided or combined without significantly altering embodiments of the invention.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

It will be evident that various modifications may be made thereto without departing from the broader spirit and scope of the invention as set forth in the following claims. For example, the methods described herein may be performed with fewer or more features/blocks or the features/blocks may be performed in differing orders. Additionally, the methods described herein may be repeated or performed in parallel with one another or in parallel with different instances of the same or similar methods.

What is claimed is:

1. A computer-implemented method comprising:
displaying a plurality of selectable partners to facilitate a financial contribution from a user;
receiving a selection of one of the plurality of partners and an amount of the financial contribution from the user;
receiving feedback generated by the selected partner and approved by an organizer to demonstrate an impact of the financial contribution, the feedback including a photograph taken of a beneficiary of the financial contribution upon receiving benefit of the financial contribution; and
displaying the feedback to the user.

2. The computer-implemented method of claim 1, wherein the feedback further includes text describing the impact of the financial contribution.

3. The computer-implemented method of claim 1, wherein the photograph includes a time stamp to demonstrate that the feedback is contemporaneous with the beneficiary receiving benefit of the financial contribution.

4. The computer-implemented method of claim 1, wherein the financial contribution comprises a recurring payment and selection of the amount of the financial contribution includes a frequency at which the recurring payment occurs.

5. The computer-implemented method of claim 4, wherein selection of the frequency at which the recurring payment occurs includes selecting that a financial contribution is automatically made in response to each time a user does one or more of (a) plays a song, (b) goes for a run, (c) reads an article, (d) watches a video, and (e) uses an application.

6. The computer-implemented method of claim 4, further comprising:
displaying cumulative progress of recurring payments made by the user with respect to a milestone.

7. The computer-implemented method of claim 1, further comprising:
displaying cumulative progress of payments made by users connected within a social network with respect to a milestone.

8. The computer-implemented method of claim 1, further comprising:
receiving user selection of another user within a social networking platform to receive an invitation to make a financial contribution to one of the plurality of partners.

9. The computer-implemented method of claim 1, further comprising:
publishing to a social networking platform an indication of the user selecting the partner or making the financial contribution.

10. The computer-implemented method of claim 1, further comprising:
displaying a partner selected by another user in response to determining that the user and the other user are connected within a social networking system.

11. A non-transitory computer-readable medium storing instructions, which when executed by a processing device, cause the processing device to perform method comprising:
displaying a plurality of selectable partners to facilitate a financial contribution from a user;
receiving a selection of one of the plurality of partners and an amount of the financial contribution from the user;
receiving feedback generated by the selected partner and approved by an organizer to demonstrate an impact of the financial contribution, the feedback including a photograph taken of a beneficiary of the financial contribution upon receiving benefit of the financial contribution; and
displaying the feedback to the user.

12. The non-transitory computer-readable medium of claim 11, wherein the feedback further includes text describing the impact of the financial contribution.

13. The non-transitory computer-readable medium of claim 11, wherein the photograph includes a time stamp to demonstrate that the feedback is contemporaneous with the beneficiary receiving benefit of the financial contribution.

14. The non-transitory computer-readable medium of claim 11, wherein the financial contribution comprises a recurring payment and selection of the amount of the financial contribution includes a frequency at which the recurring payment occurs.

15. The non-transitory computer-readable medium of claim 14, wherein selection of the frequency at which the recurring payment occurs includes selecting that a financial contribution is automatically made in response to each time a user does one or more of (a) plays a song, (b) goes for a run, (c) reads an article, (d) watches a video, and (e) uses an application.

16. The non-transitory computer-readable medium of claim 14, the method further comprising:
displaying cumulative progress of recurring payments made by the user with respect to a milestone.

17. The non-transitory computer-readable medium of claim 11, the method further comprising:
displaying cumulative progress of payments made by users connected within a social network with respect to a milestone.

18. The non-transitory computer-readable medium of claim 11, the method further comprising:
receiving user selection of another user within a social networking platform to receive an invitation to make a financial contribution to one of the plurality of partners.

19. The non-transitory computer-readable medium of claim 11, the method further comprising:
publishing to a social networking platform an indication of the user selecting the partner or making the financial contribution.

20. The non-transitory computer-readable medium of claim 11, the method further comprising:
displaying a partner selected by another user in response to determining that the user and the other user are connected within a social networking system.

21. An apparatus comprising:
a processing device, wherein the processing device executes instructions that cause the apparatus to
display a plurality of selectable partners to facilitate a financial contribution from a user;
receive a selection of one of the plurality of partners and an amount of the financial contribution from the user;
receive feedback generated by the selected partner and approved by an organizer to demonstrate an impact of the financial contribution, the feedback including a photograph taken of a beneficiary of the financial contribution upon receiving benefit of the financial contribution; and
display the feedback to the user.
